(19) United States
(12) Patent Application Publication
(10) Pub. No.: US 2017/0192279 A1
(43) Pub. Date: Jul. 6, 2017

(54) DISPLAY DEVICE

(71) Applicant: Japan Display Inc., Minato-ku (JP)

(72) Inventors: Yuji MAEDE, Tokyo (JP); Jin HIROSAWA, Tokyo (JP)

(73) Assignee: Japan Display Inc., Minato-ku (JP)

(21) Appl. No.: 15/393,762

(22) Filed: Dec. 29, 2016

(30) Foreign Application Priority Data
Jan. 5, 2016 (JP) 2016-000545

(51) Int. Cl. G02F 1/1339; G02F 1/1335; G02F 1/1368; G02F 1/1333; G02F 1/1362

(52) U.S. Cl. CPC G02F 1/13394; G02F 1/13338; G02F 1/136227; G02F 1/136286; G02F 1/1368; G02F 1/133512; G02F 1/133514; G02F 2001/13396

(57) ABSTRACT

According to one embodiment, a display device includes a first substrate, a second substrate and a liquid crystal layer. The first substrate includes a first signal line, common electrodes, and metal lines connecting to the common electrodes. The second substrate is opposed to the first substrate. The liquid crystal layer is enclosed between the first substrate and the second substrate. The metal lines includes a first metal line crossing the first signal line, a second metal line provided separately from the first metal line, and a third metal line connecting the first metal line and the second metal line.

### CROSS-REFERENCE TO RELATED APPLICATIONS

This application is based upon and claims the benefit of priority from Japanese Patent Application No. 2016-000545, filed Jan. 5, 2016, the entire contents of which are incorporated herein by reference.

### FIELD

Embodiments described herein relate generally to a display device.

### BACKGROUND

In recent years, flat-panel display devices have been developed intensively; among them, liquid crystal display devices have attracted considerable attention in view of their advantages of lightness, thinness, reduced power consumption, etc. In a liquid crystal display device, an array substrate provided with both of a pixel electrode and a common electrode, and a counter-electrode opposed to the array substrate are disposed. A liquid crystal layer is held between the array substrate and the counter-substrate. An image is formed by controlling the light transmittance of liquid crystal molecules per pixel.

In recent years, display devices with a touch detection function comprising drive electrodes and touch detection electrodes have been developed. The drive electrodes function as drive electrodes of touch detection devices as well as functioning as common drive electrodes of liquid crystal display devices. As an example, a technique of forming drive electrodes in such a way that they extend in the same direction as that of pixel signal lines has been known. It has been demanded that in such display devices, a deterioration in display quality and a decline in touch detection performance due to the drive electrodes be restrained.

Incidentally, to keep a distance (cell gap) between an array substrate and a counter-electrode, a columnar spacer (hereinafter, also referred to as a first columnar spacer or main spacer) is provided. In addition to the main spacer, a columnar spacer (hereinafter, also referred to as a second columnar spacer or sub-spacer) which functions in an auxiliary manner when external pressure is applied to the counter-substrate may be provided. The peripheries of points at which spacers are provided are shielded from light by a light-shielding layer. Thus, the areas of opening portions, which contribute to display, are reduced in pixels located around the spacers. It is therefore demanded that the spacers be disposed without causing a deterioration in display quality such as white balance.

### BRIEF DESCRIPTION OF THE DRAWINGS

FIG. 1 is a plan view showing a schematic structure of a liquid crystal display device according to one of the embodiments.

FIG. 2 is a diagram showing an example of a principle on which an object in contact with or in proximity to a display area is detected.

FIG. 3 is a diagram showing a schematic equivalent circuit related to image display in the liquid crystal display device according to the one of the embodiments.

FIG. 4 is a schematic plan view of color filters formed on the counter-substrate side from the perspective of the array substrate side.

FIG. 5 is an enlarged view of an area surrounded by an alternate long and short dashed line of FIG. 4.

FIG. 6 is a schematic plan view of the area surrounded by the alternate long and short dashed line of FIG. 4 from the perspective of the counter-substrate side.

FIG. 7 is a sectional view showing a part of the liquid crystal display device 1 along line A-A′ of FIG. 6.

FIG. 8 is a schematic plan view of color filters formed on the counter-substrate side from the perspective of the array substrate side in a conventional liquid crystal display device.

FIG. 9 is a schematic plan view of a metal layer formed near a first spacer from the perspective of the array substrate side.

FIG. 10 is a schematic plan view of an area surrounded by an alternate long and short dashed line of FIG. 9 from the perspective of the counter-substrate side.

FIG. 11 is a schematic plan view of the metal layer formed near the first spacer from the perspective of the array substrate side.

FIG. 12 is a schematic plan view of an area surrounded by an alternate long and short dashed line of FIG. 11 from the perspective of the counter-substrate side.

FIG. 13 is a diagram of the metal layer formed near the first spacer from the perspective of the counter-substrate side.

### DETAILED DESCRIPTION

In general, according to one embodiment, a display device includes a first substrate, a second substrate and a liquid crystal layer. The first substrate includes a first signal line, common electrodes, and metal lines connecting to the common electrodes. The second substrate is opposed to the first substrate. The liquid crystal layer is enclosed between the first substrate and the second substrate. The metal lines includes a first metal line crossing the first signal line, a second metal line provided separately from the first metal line, and a third metal line connecting the first metal line and the second metal line.

Embodiments will be described with reference to the accompanying drawings.

The disclosure is merely an example, and proper changes within the spirit of the invention, which are easily conceivable by a person with ordinary skill in the art, are included in the scope of the present invention as a matter of course. In addition, in some cases, in order to make the description clearer, the drawings may be more schematic than in the actual modes. They merely show examples, and do not limit the interpretation of the present invention. In the drawings, the reference numbers of the same or similar elements that are successively arranged may be omitted. In the specification and the drawings, structural elements performing the same functions as or similar functions to those already described will be given the same reference numbers, and overlapping detailed description may be omitted.

In each of the embodiments, as an example of a display device, a display device comprising a display panel in which a liquid crystal display element is used and having a touch detection function is disclosed. However, each of the embodiments does not preclude the application of individual technical ideas disclosed in the embodiments to display devices in which display elements other than a liquid crystal display element are used. As display elements other than a liquid crystal display element, a self-luminous display panel comprising an organic electroluminescent display element or the like, an electronic-paper type display panel comprising a cataphoretic element or the like, etc., are assumed. For example, if a self-luminous display panel comprising an organic electroluminescent display element or the like is assumed as a display device in which a display element other than a liquid crystal display element is used, the individual technical ideas disclosed in the embodiments may be applied thereto, for example, by replacing first electrodes, second electrodes, and an interlayer film, which will be described later, with anodes, cathodes, and a light-emitting layer, respectively.

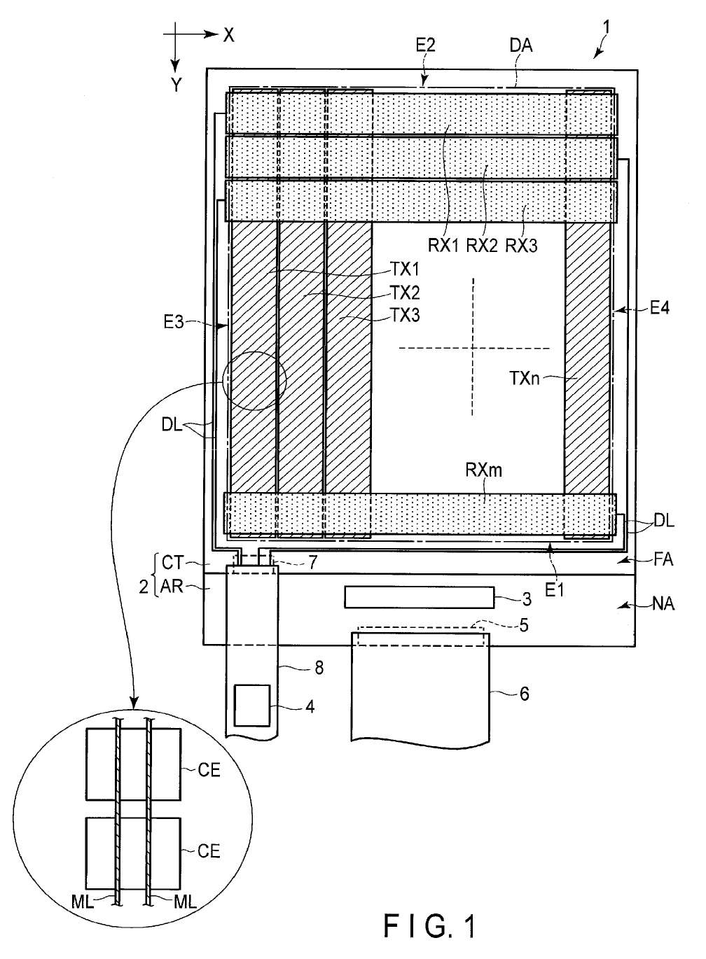

FIG. 1 is a plan view showing a schematic structure of a liquid crystal display device 1 according to one of the embodiments. The liquid crystal display device 1 can be used in various devices, for example, a smartphone, a tablet computer, a feature phone, a personal computer, a television set, vehicle-mounted equipment, and a game console.

The liquid crystal display device 1 comprises a liquid crystal display panel 2, drive electrodes TX (TX1 to TXn), detection electrodes RX (RX1 to RXm) opposed to the respective drive electrodes TX, a driver IC 3 functioning as a driver module, and a touch detection IC 4 functioning as a detection module. For example, n and m are integers greater than or equal to two.

The liquid crystal display panel 2 comprises a rectangular array substrate (first substrate) AR and a rectangular counter-substrate (second substrate) CT smaller in shape than the array substrate AR. In the example of FIG. 1, the array substrate AR and the counter-substrate CT are attached to each other in such a way that three sides of each substrate are laid on three sides of the other substrate. The array substrate AR comprises a terminal area NA (unopposed area) not opposed to the counter-substrate CT.

In an area where the array substrate AR and the counter-substrate CT are opposed, the liquid crystal display panel 2 comprises a display area (active area) DA where an image is displayed and a peripheral area FA between the display area DA and end portions of the liquid crystal display panel 2. In the example of FIG. 1, the display area DA is a rectangle comprising a first side E1 on the terminal area NA side, a second side E2 opposite to the first side E1, and a third side E3 and a fourth side E4 connecting the first side E1 and the second side E2. In the following description, a direction parallel to the first side E1 and the second side E2 will be referred to as a first direction X, and a direction parallel to the third side E3 and the fourth side E4 will be referred to as a second direction Y. In the present embodiment, the first direction X and the second direction Y cross perpendicularly. However, the first direction X and the second direction Y may cross at other angles.

In the display area DA, the drive electrodes TX1 to TXn extend from the first side E1 to the second side E2 in the second direction Y, and are arranged in the first direction X. The drive electrodes TX1 to TXn are each composed of common electrodes CE formed of a transparent conductive film of, for example, indium tin oxide (ITO). More specifically, the drive electrode TX1 in the shown example comprises common electrodes CE divided in the first direction X and arranged in the second direction Y, and metal layers ML electrically connecting the common electrodes CE arranged in the second direction Y. The drive electrodes TX1 to TXn are formed, for example, in the liquid crystal display panel 2, that is, in the array substrate AR.

In the display area DA, the detection electrodes RX1 to RXm extend from the third side E3 to the fourth side E4 in the first direction X, and are arranged in the second direction Y. The detection electrodes RX1 to RXm can be formed of a transparent conductive film of ITO, etc., or a conductive pattern in which a metal line is used. The detection electrodes RX1 to RXm are formed, for example, on a surface of the counter-substrate CT, which is opposite to a surface opposed to the array substrate AR.

The driver IC 3 executes control related to image display, and mounted in the terminal area NA. The driver IC 3 is mounted by, for example, a chip-on-glass (COG) method, but may also be mounted on a first flexible printed circuit 6.

In the terminal area NA, a mounting terminal 5 is formed. To the mounting terminal 5, the first flexible printed circuit 6, which supplies image data to the liquid crystal display panel 2, is connected.

At an end portion of the counter-substrate CT along the terminal area NA, a mounting terminal 7 is formed. To the mounting terminal 7, a second flexible printed circuit 8 which outputs a detection signal from the detection electrodes RX1 to RXm is connected. In the example of FIG. 1, the touch detection IC 4 is mounted on the second flexible printed circuit 8.

The detection electrodes RX1 to RXm are, for example, connected to the mounting terminal 7 via detection lines DL formed on the surface of the counter-substrate CT in the peripheral area FA.

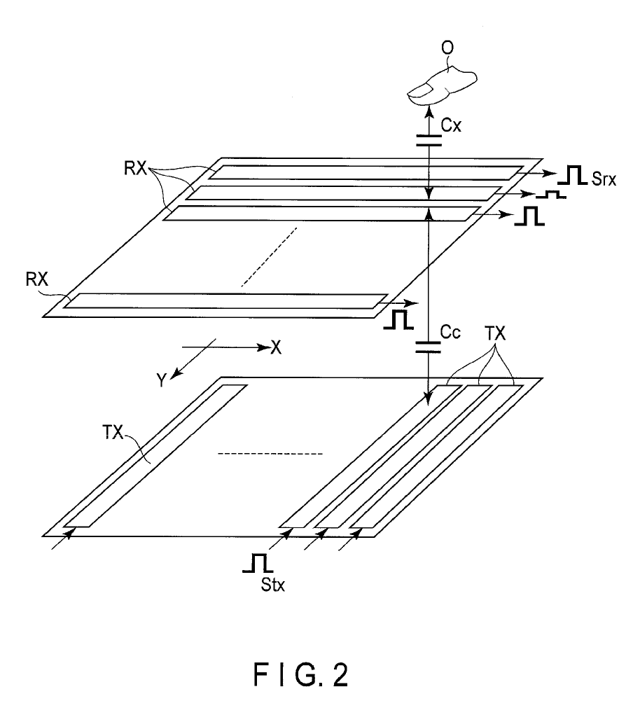

Next, an example of the principle of a sensor which detects an object in contact with or in proximity to the display area DA by the drive electrodes TX and the detection electrodes RX will be described with reference to FIG. 2.

Capacitance Cc exists between a drive electrode TX and a detection electrode RX which are opposed to each other. When a drive signal Stx is supplied to the drive electrode TX, a current flows through the detection electrode RX via the capacitance Cc, and thus, a detection signal Srx is obtained from the detection electrode RX. The drive signal Stx is, for example, a rectangular pulse, and the detection signal Srx is a rectangular pulse of a voltage corresponding to the drive signal Stx.

When an object O, which is a conductor such as a user's finger, approaches the liquid crystal display device 1, capacitance Cx is produced between a detection electrode RX in proximity to the object O and the object O. When a drive signal Stx is supplied to a drive electrode TX, a waveform of a detection signal Srx obtained from the detection electrode RX in proximity to the object O changes under the influence of the capacitance Cx. That is, the touch detection IC 4 can detect the object O in contact with or in proximity to the display device 1 on the basis of detection signals Srx obtained from the respective detection electrodes RX. In addition, the touch detection IC 4 can detect the positions of the object O in the first direction X and the second direction Y on the basis of detection signals Srx obtained from the respective detection electrodes RX in each time phase when drive signals Stx are sequentially supplied to the respective drive electrodes TX in a time-division manner. The above-described method is called a mutual-capacitive method, a mutual-detection method, or the like.

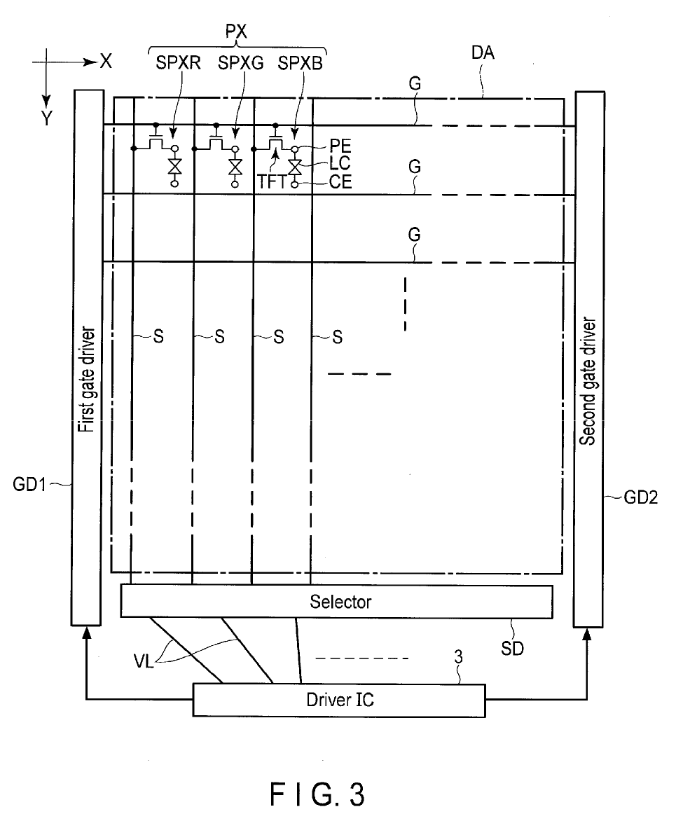

Next, the image display of the liquid crystal display device 1 will be described. FIG. 3 is a diagram showing a schematic equivalent circuit related to image display. The liquid crystal display device 1 comprises gate lines (scanning lines) G, source lines S crossing the gate lines G, a first gate driver GD1, a second gate driver GD2, and a selector (RGB switch) SD. The selector SD is connected to the driver IC 3 via video lines VL.

In the display area DA, the gate lines G each extend in the first direction X, and are arranged in the second direction Y. In the display area DA, the source lines S each extend in the second direction Y, and are arranged in the first direction X. Each of the gate lines G and each of the source lines S are formed on the array substrate AR. Each of the gate lines G is connected to the first gate driver GD1 and the second gate driver GD2. Each of the source lines S is connected to the selector SD.

In the example of FIG. 3, an area partitioned by each of the gate lines G and each of the source lines S corresponds to one sub-pixel SPX. For example, in the present embodiment, each pixel PX is constituted of a sub-pixel (hereinafter, referred to as a red pixel) SPXR corresponding to red, a sub-pixel (hereinafter, referred to as a green pixel) SPXG corresponding to green, and a sub-pixel (hereinafter, referred to as a blue pixel) SPXB corresponding to blue. The pixel PX may further comprise a sub-pixel SPXW corresponding to white, etc.

Each of the sub-pixels SPX comprises a thin-film transistor TFT (switching element) formed on the array substrate AR. The thin-film transistor TFT is electrically connected to a gate line G, a source line S, and a pixel electrode PE. At the time of display, the common electrodes CE are set at a common potential.

The first gate driver GD1 and the second gate driver GD2 sequentially supply a scanning signal to each of the gate lines G. The selector SD selectively supplies a video signal to each of the source lines S under the control of the driver IC 3. When a scanning signal is supplied to a gate line G connected to a thin-film transistor TFT, and a video signal is supplied to a source line S connected to the thin-film transistor TFT, a voltage according to the video signal is applied to a pixel electrode PE. At this time, the alignment of liquid crystal molecules of a liquid crystal display layer LC enclosed between the array substrate AR and the counter-substrate CT changes from an initial alignment state in which the voltage is not applied because of an electric field produced between the pixel electrode PE and a common electrode CE. Through the above-described operation, an image is displayed in the display area DA.

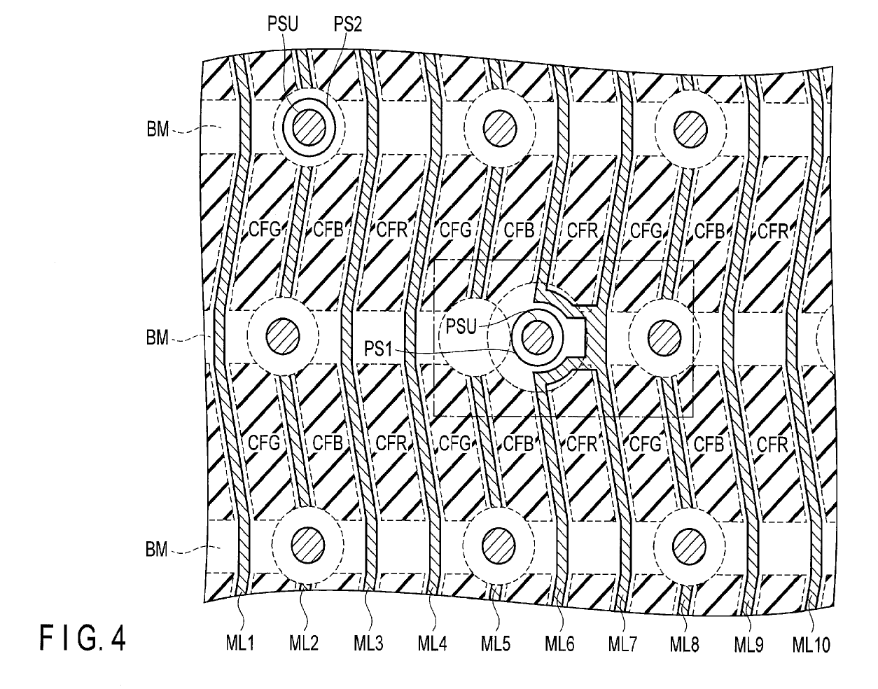

FIG. 4 is a schematic plan view of color filters CFR, CFG, and CFB formed on the counter-substrate CT side, which correspond to a number of sub-pixels SPXR, SPXG, and SPXB formed on the array substrate AR, respectively, from the perspective of the array substrate AR side. In FIG. 4, light-shielding layers for shielding columnar spacers PS provided between the array substrate AR and the counter-substrate CT (projecting through the liquid crystal layer LC) from light, and black matrices BM (light-shielding layers) provided between each color filter CF are indicated by broken lines.

A columnar first spacer PS1 for determining the distance (cell gap) between the array substrate AR and the counter-substrate CT is formed in the space (boundary) between a blue color filter CFB and a red color filter CFR, which correspond to a blue pixel SPXB and a red pixel SPXR, respectively, of three sub-pixels SPXR, SPXG, and SPXB constituting each pixel PX. In other words, the first spacer PS1 is formed to determine the height of the liquid crystal layer LC. The height of the first spacer PS1 is greater than that of a columnar second spacer PS2, which is similarly formed in the liquid crystal layer LC. The first spacer PS1 may be referred to as a main spacer.

In this manner, the first spacer PS1 is formed between the blue color filter CFB and the red color filter CFR corresponding to the blue pixel SPXB and the red pixel SPXR, respectively, which are sub-pixels other than the green pixel SPXG, especially highly visible to human eyes. The following advantage can be thereby obtained: for example, when pressure (external pressure) is applied from outside, the tip portion of a spacer is pressed against an alignment film, thereby leaving the imprint of the spacer, and light leaks from the imprint; even in this case, the light leakage can be made hard to recognize by human eyes (that is, linear non-uniformity due to the light leakage can be made hard to notice), because the light leakage occurs in the blue pixel SPXB or the red pixel SPXR, which is less visible than green.

A second spacer PS2 for receiving pressure from outside is formed between a green color filter CFG and a blue color filter CFB corresponding to a green pixel SPXG and a blue pixel SPXB, respectively, of three sub-pixels constituting each pixel PX. As described above, the second spacer PS2 is required to receive pressure from outside. Accordingly, the number of second spacers PS2 is greater than that of first spacers PS1. Specifically, the number of second spacers PS2 is 10 or more times greater than that of first spacers PS1. In FIG. 4, spacers other than that shown as a first spacer PS1 are all second spacers PS2. The second spacers PS2 may be referred to as sub-spacers.

The height of the first spacers PS1 is greater than that of the second spacers PS2 as described above. Thus, the first spacers SP1 are greatly deformed when pressure is applied from outside. Therefore, the diameter of black matrices BM corresponding to the first spacers PS1 is greater than that of black matrices BM corresponding to the second spacers PS2. However, as described above, the number of second spacers PS2 is 10 or more times greater than that of first spacers PS1. Thus, in the whole display area DA, an area occupied by the black matrices BM corresponding to the second spacers PS2 is larger than that occupied by the black matrices BM corresponding to the first spacers PS1. That is, in terms of an improvement in transmittance, the second spacers PS2, the corresponding black matrices BM of which occupy a larger area, make a greater contribution than the first spacers PS1. Thus, the transmittance of the whole liquid crystal display device 1 (display area DA) can be improved by forming the second spacers PS2 between the color filters CFG and CFB other than red, which is a color that generally makes the greatest contribution to an improvement in transmittance.

In FIG. 4, it is assumed that the shapes of the bottom surfaces (surfaces on the counter-substrate CT side) of the first and second spacers PS1 and PS2 are circles. Accordingly, the shapes of the respective black matrices BM corresponding to the first and second spacers PS1 and PS2 are circles. That is, the shapes of the black matrices BM are appropriately changed in accordance with the shapes of the bottom surfaces of the corresponding spacers. For example, if the shapes of the bottom surfaces of the spacers are quadrangles, it is preferable that the shapes of the corresponding black matrices be quadrangles. At this time, it is more preferable that the shapes of the corresponding black matrices BM be quadrangles similar to those of the bottom surfaces of the spacers.

In FIG. 4, only one of the bottom surfaces of the second spacers PS2 is shown for the convenience of description. The same is true of those of the other second spacers PS2. Also in the subsequent figures, only one of the bottom surfaces of the second spacers PS2 is shown, and the bottom surfaces of the other second spacers PS2 are omitted as appropriate. Moreover, in FIG. 4, although a second spacer PS2 is not disposed at a point adjacent to a first spacer PS1, a black matrix BM corresponding to the second spacer PS2 is formed.

Metal layers (metal lines) ML1 to ML10 are formed to cross the gate lines G extending in the first direction X, and each electrically connect the common electrodes CE arranged in the second direction Y shown in FIG. 1. The common electrodes CE arranged in the second direction Y are thereby set at the same potential, and the drive electrodes TX shown in FIG. 1 are formed. The resistance of the metal layers ML1 to ML10 is lower than that of a transparent conductive film of ITO, etc. Thus, the resistance of the drive electrodes TX can be restrained low by connecting the common electrodes CE by the metal layers ML1 to ML10. The metal layers ML2, ML5, and ML8 are divided at points at which the second spacers PS2 are disposed, and do not function as drive electrodes TX, which will be described later in detail. Thus, the metal layers ML2, ML5, and ML8 may be omitted. On the other hand, these metal layers ML are located at the boundaries between color pixels adjacent in the first direction X, and thus can shut out light transmitting through the other color pixels and restrain a color mixture when the liquid crystal display device is viewed obliquely. It is therefore preferable that even metal layers which contribute to a reduction in the resistance of the drive electrodes TX slightly be disposed at the boundaries between color pixels. The metal layers ML1 to ML10 are formed of metal materials such as molybdenum, tungsten, aluminum, titanium, and copper, an alloy including these metal materials, or the like. The metal layers ML1 to ML10 may have a single-layer structure or a multilayered structure.

The first and second spacers PS1 and PS2 are disposed, for example, near the intersections of the gate lines G and the source lines S shown in FIG. 3. Thus, the metal layers ML2, ML5, ML6, and ML8 are divided near the intersections of the gate lines G and the source lines S or at points at which they are superposed on the gate lines G. The metal layer ML6 detours and is connected to the metal layer ML7 as will be described later.

In FIG. 4, the metal layers ML1 to ML10 are not formed at portions (hereinafter, referred to as spacer-grounded portions) PSU at which the tip portions of the first and second spacers PS1 and PS2 formed on the counter-substrate CT contact the array substrate AR (alignment film). In addition, the same is true of the other spacer-grounded portions not shown in the figure of the display area DA. This is because if the metal layers ML are formed on the spacer-grounded portions PSU, and for example, pressure from outside is applied, the tip portions of the first and second spacers PS1 and PS2 do not necessarily contact the metal layers. For example, if the tip portion of a certain spacer contacts a metal layer, but the tip portion of another spacer contacts the array substrate AR without contacting a metal layer, when pressure from outside is applied, the pressure from outside is not equally applied to each of the spacers. Thus, the spacers may be damaged. In contrast, as shown in FIG. 4, in the structure in which no metal layer ML is formed on all the spacer-grounded portions PSU, when pressure from outside is applied, the first and second spacers PS1 and PS2 contact the array substrate AR, and the pressure from outside is dispersed to each of the spacers. Thus, the spacers can be restrained from being damaged.

As shown in FIG. 4, the metal layer ML6 formed between a blue pixel SPXB and a red pixel SPXR corresponding to a blue color filter CFB and a red color filter CFR, respectively, between which the first spacer PS1 is disposed, is connected to the metal layer ML7 formed between the red pixel SPXR and a green pixel SPXG (that is, adjacent to the metal layer ML6). Specifically, the metal layer ML6 between the blue pixel SPXB and the red pixel SPXR is formed in such a way that it detours around the spacer-grounded portion PSU of the first spacer PS1 at the point at which the first spacer PS1 is disposed and is connected to the adjacent metal layer ML7.

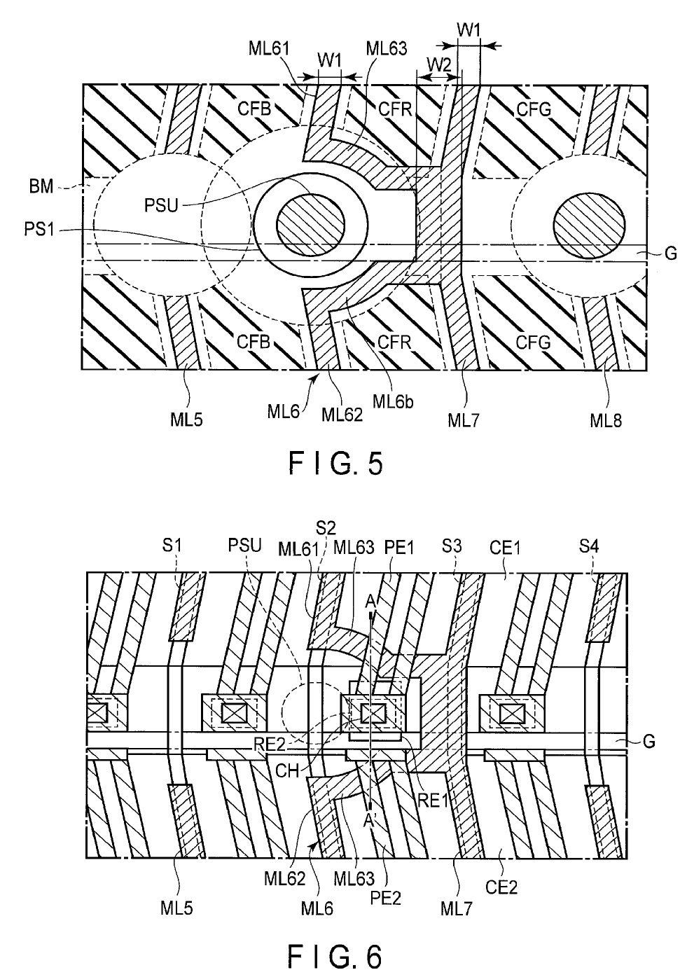

FIG. 5 is an enlarged view of an area surrounded by an alternate long and short dashed line of FIG. 4. In the figure, a gate line G is indicated by alternate long and short dashed lines. The metal layer ML7 (first metal layer) crosses the gate line G. The metal layer ML6 is provided to be adjacent to the metal layer ML7, and formed between the blue pixel SPXB and the red pixel SPXR, between which the first spacer PS1 is disposed. The metal layer ML6 includes first portions ML61 and ML62 (second metal layers) separated at a point superposed on the gate line G, and a second portion ML63 (third metal layer) connecting the first portions ML61 and ML62 and the metal layer ML7. In the shown example, each of the metal layer ML5 and the metal layer ML8 is divided at points superposed on the gate line G.

The first portions ML61 and ML62 extend in a curve in the second direction Y. The second portion ML63 detours around the spacer-grounded portion PSU of the first spacer PS1. From one point of view, one end side of the second portion ML63 is connected to the first portion ML61, the other end side of the second portion ML63 is connected to the first portion ML62, and a middle portion of the second portion ML63 is connected to the metal layer ML7. The first portions ML61 and ML62 are formed to be within black matrices BM formed between blue color filters CFB and red color filters CFR. In addition, most of the second portion ML63 is formed to be within a black matrix BM which shields the periphery of the first spacer PS1 from light. In FIG. 5, the shape of the black matrix BM corresponding to the first spacer PS1 is a circle as described above. Thus, the second portion ML63 is formed along the arc of the circular black matrix BM corresponding to the first spacer PS1.

The first portion M61 of the metal layer ML6 and the metal layer ML7 have a first line width W1. In addition, the connecting portion between the second portion ML63 and the metal layer ML7 has a second line width W2 greater than the first line width W1. The second line width W2 is greater than or equal to 1.1 times the first line width W1, but less than or equal to 3.0 times the first line width W1. It is preferable that the second line width W2 is greater than or equal to 1.6 times the first line width W1, but less than or equal to 2.4 times the first line width W1. For example, the second line width W2 is approximately twice the first line width W1. This enables each of the metal layers ML6 and ML7 to function as a drive electrode TX without causing an increase in the resistance.

FIG. 6 is a schematic plan view of the area surrounded by the alternate long and short dashed line of FIG. 4 from the perspective of the counter-substrate CT side. The gate line G shown in FIG. 6 may be referred to as a first signal line. FIG. 6 shows source lines S1 to S4 crossing the gate line G. The source line S2, the source line S3, and the source line S1 may be referred to as a second signal line, a third signal line, and a fourth signal line, respectively. The description herein focuses on pixel electrodes PE1 and PE2 located around the periphery of the spacer-grounded portion PSU of the first spacer PS1. The spacer-grounded portion PSU is located near the intersection of the gate line G and a source line S shown in the figure. The pixel electrode PE1 is opposed to a common electrode CE1, and the pixel electrode PE2 is opposed to a common electrode CE2. The common electrodes CE1 and CE2 are separated at a point superposed on the gate line G. The pixel electrode PE1 is connected to a switching element electrically connected to the gate line G and the source line S shown in the figure via relay electrodes RE1 and RE2 in a contact hole CH. The relay electrode RE1 is located in the same layer as the source line S, and the relay electrode RE2 is located in the same layer as the common electrode CE1, etc. In the present embodiment, the common electrode CE1 and the common electrode CE2 are separated in an area where the gate line G is formed. However, this imposes any restrictions, and the common electrode CE1 and the common electrode CE2 may be connected by a transparent conductive film located in the same layer as the common electrode CE1 and the common electrode CE2 at a point at which the metal layer ML5 is divided or a point at which the metal layer ML7 is provided. If the common electrode CE1 and the common electrode CE2 are connected by the transparent conductive film, it is preferable for the above reason that they be connected at points except a point at which a spacer is provided. However, the above-described problem can be solved by connecting the common electrode CE1 and the common electrode CE2 by a transparent conductive film having a width greater than the width W1 of metal layers.

The first portions ML61 and ML62 of the metal layer ML6 are superposed on the source line S. The second portion ML63 detours around the spacer-grounded portion PSU and the contact hole CH, and is connected to the metal layer ML7. The metal layers ML6 and ML7 connect the common electrodes CE1 and CE2 separated from each other.

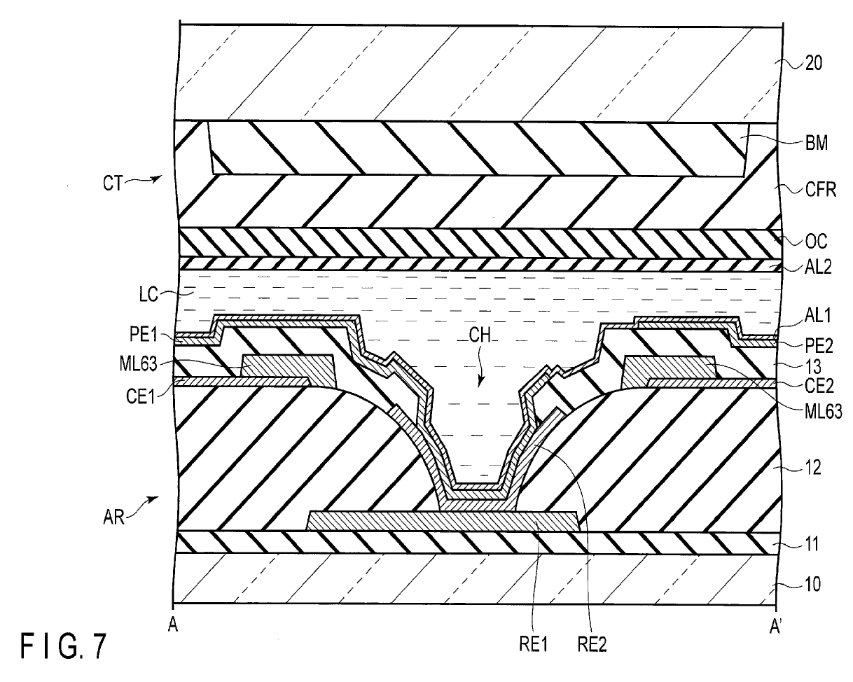

FIG. 7 is a sectional view showing a part of the liquid crystal display device 1 along line A-A′ of FIG. 6. In the shown sectional view, the structure of a switching element, etc., located below the relay electrode RE1 is omitted.

The array substrate AR and the counter-substrate CT are attached to each other in a state in which the above-described cell gap is determined (formed) by the first spacer PS1 herein not shown in the figure. In a space formed by the cell gap, the liquid crystal layer LC is enclosed.

The array substrate AR comprises a first insulating substrate 10 having a light transmitting property, such as a glass substrate or a resin substrate. The array substrate AR comprises the relay electrodes RE1 and RE2, the common electrodes CE1 and CE2 (first electrodes), the pixel electrodes PE1 and PE2 (second electrodes), the second portion ML63 of the metal layer ML6, a first insulating film 11, a second insulating film 12, a third insulating film 13 (interlayer film), a first alignment film AL1, etc., as well as a switching element, a gate line, and a source line not shown in the figure, on the counter-substrate CT side of the first insulating substrate 10.

The first insulating film 11 is formed on the counter-substrate CT side of the first insulating substrate 10. The relay electrode RE1 electrically connected to the switching element is located on the first insulating film 11. The second insulating film 12 covers the relay electrode RE1 and the first insulating film 11. The relay electrode RE1 is formed in the same layer as a source line S not shown in the figure. Thus, the second insulating film 12 also covers the source line S. The second insulating film 12 is penetrated to the relay electrode RE1 in the contact hole CH. The common electrodes CE1 and CE2 are located on the second insulating film 12. The relay electrode RE2 contacts the relay electrode RE1 in the contact hole CH. The relay electrode RE2 is formed in the same layer as the common electrodes CE1 and CE2, but is separated and electrically insulated from the common electrodes CE1 and CE2. The relay electrode RE2 is formed of, for example, the same transparent conductive material as the common electrodes CE1 and CE2.

A metal layer such as the second portion ML63 contacts the upper surfaces of the second insulating film 12 and the common electrodes CE1 and CE2. The third insulating film 13 covers a metal layer such as the second portion ML63, the second insulating film 12, and the common electrodes CE1 and CE2. The third insulating film 13 is penetrated to the relay electrode RE2 in the contact hole CH. The pixel electrodes PE1 and PE2 are located on the third insulating film 13, and opposed to the common electrodes CE1 and CE2, respectively. The pixel electrode PE1 contacts the relay electrode RE2 in the contact hole CH. The first alignment film AL1 covers the pixel electrodes PE1 and PE2 and the third insulating film 13.

On the other hand, the counter-substrate CT comprises a second insulating substrate 20 having a light transmitting property, such as a glass substrate or a resin substrate. The counter-substrate CT comprises a black matrix BM, a red color filter CFR, an overcoat layer OC, a second alignment film AL2, etc., on the array substrate AR side of the second insulating substrate 20.

The black matrix BM and the red color filter CFR are formed on the array substrate AR side of the second insulating substrate 20. The overcoat layer OC covers the red color filter CFR. The second alignment film AL2 covers the overcoat layer OC.

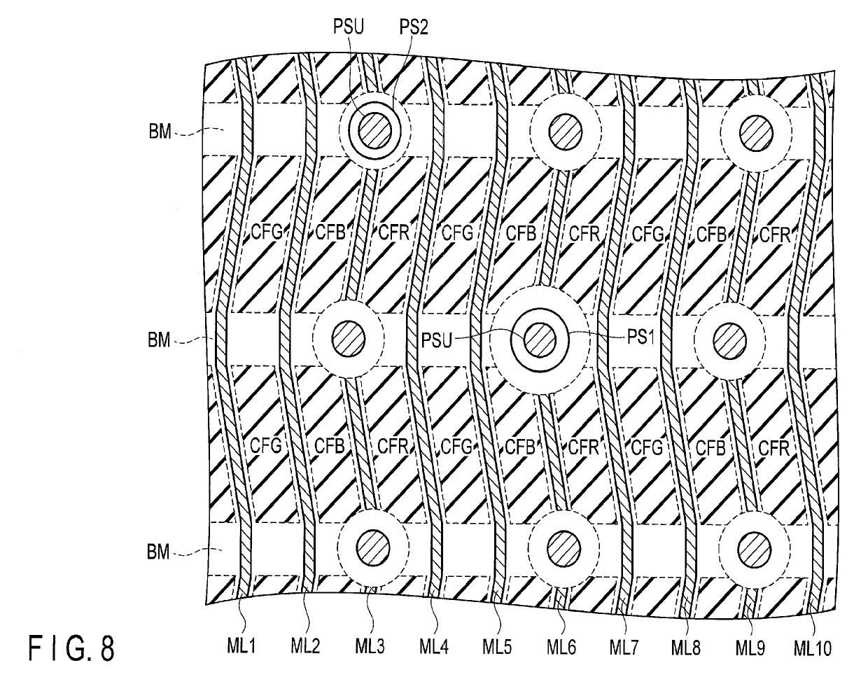

Advantages obtained from the present embodiment will be herein described by comparing the liquid crystal display device 1 according to the present embodiment and a liquid crystal display device having the structure shown in FIG. 8. The liquid crystal display device having the structure shown in FIG. 8 differs from the liquid crystal display device 1 according to the present embodiment in that all the second spacers PS2 are disposed between blue color filters CFB and red color filters CFR corresponding to blue pixels SPXB and red pixels SPXR, respectively. In addition, the liquid crystal display device having the structure shown in FIG. 8 differs from the liquid crystal display device 1 according to the present embodiment also in that the metal layer ML6 near the first spacer PS1 (or the metal layer ML6 formed between blue pixels SPXB and red pixels SPXR) is divided at a point at which the first spacer PS1 is formed without being connected to the adjacent metal layer ML7 (or the metal layer ML7 formed between the red pixels SPXR and green pixels SPXG).

In the liquid crystal display device having the structure shown in FIG. 8, the first spacer PSI is disposed between a blue color filter CFB and a red color filter CFR corresponding to sub-pixels other than a green pixel SPXG, which is especially highly visible to human eyes, that is, a blue pixel SPXB and a red pixel SPXR, respectively. Accordingly, in the liquid crystal display device, if the imprint of the spacer is left by pressure from outside, etc., and a light leakage due to the imprint of the spacer occurs to cause linear non-uniformity, the linear non-uniformity can be made hard to recognize. In addition, the liquid crystal display device can also satisfy the demand that at least two metal layers ML penetrate the display area DA per pixel PX to reduce the resistance of the drive electrodes TX. Specifically, the second spacers PS2 are disposed between blue color filters CFB and red color filters CFR corresponding to blue pixels SPXB and red pixels SPXR, respectively, as in the case of the first spacer PS1. Thus, metal layers ML formed between the red pixels SPXR and green pixels SPXG and metal layers ML formed between the green pixels SPXG and the blue pixels SPXB penetrate the display area DA, and the resistance of the drive electrodes TX can be reduced.

However, in the liquid crystal display device having the structure shown in FIG. 8, both of the first and second spacers PS1 and PS2 are disposed near the red color filters CFR, which are in a color that makes the greatest contribution to an improvement in transmittance (or between the blue color filters CFB and the red color filters CFR). If the first and second spacers PS1 and PS2 are disposed, black matrices BM corresponding to these spacers are also disposed. The disposition of these black matrices BM near the red color filters CFR, which make the greatest contribution to an improvement in transmittance, causes a problem that the transmittance of the whole liquid crystal display device is reduced.

In addition, in the liquid crystal display device having the structure shown in FIG. 8, both of the first and second spacers PS1 and PS2 are disposed between the blue color filters CFB and the red color filters CFR. Thus, no spacer is disposed near the green color filters CFG. That is, black matrices BM corresponding to spacers are not disposed near the green color filters CFG, either. Accordingly, the transmittance of the green pixels SPXG is greater than that of the other pixels, that is, the red pixels SPXR and the blue pixels SPXB, and a problem that the balance of white (white balance) is disturbed is caused. To solve this problem, the transmittance of the green pixels SPXG needs to be reduced intentionally. However, this causes another problem that the transmittance of the whole liquid crystal display device declines, thereby leading to a decline in brightness.

As described above, in the liquid crystal display device having the structure shown in FIG. 8, linear non-uniformity due to the imprint of a spacer can be made hard to recognize, and the resistance of the drive electrodes TX can be reduced. However, there is a problem the transmittance of the whole liquid crystal display device cannot be improved.

In contrast, the liquid crystal display device 1 according to the present embodiment has the structure in which the first spacers PS1 are disposed between the blue color filters CFB and the red color filters CFR corresponding to pixels other than the green pixels SPXG, which are especially highly visible, that is, the blue pixels SPXB and the red pixels SPXR, respectively, whereas the second spacers PS2 are disposed between the color filters CFG and CFB having colors other than red, which makes the greatest contribution to an improvement in transmittance.

Moreover, the demand that at least two metal layers ML penetrate the display area DA per pixel PX, that is, a reduction in the resistance of the drive electrodes TX, cannot be fulfilled merely by disposing the first spacers PS1 between the blue color filters CFB and the red color filters CFR and disposing the second spacers PS2 between the green color filters CFG and the blue color filters CFB. Specifically, this is because the metal layers ML formed between the blue pixels SPXB and the red pixels SPXR are divided at points at which the first spacers PS1 are disposed, and the metal layers ML disposed between the green pixels SPXG and the blue pixels SPXB are divided at points at which the second spacers PS2 are disposed. However, the liquid crystal display device 1 according to the present embodiment has the structure in which the metal layers ML formed between the blue pixels SPXB and the red pixels SPXR corresponding to the blue color filters CFB and the red color filters CFR, between which the first spacers PS1 are disposed, respectively, detour around the spacer-grounded portions PSU of the first spacers PS1 and are connected to adjacent metal layers ML. Accordingly, the metal layers ML formed between the red pixels SPXR and the green pixels SPXG and the metal layers ML formed between the blue pixels SPXB and the red pixels SPXR penetrate the display area DA, and the resistance of the drive electrodes TX can also be reduced.

In the present embodiment, as shown in FIG. 6, the metal layer ML6 near the first spacer PS1 has a shape which detours around the spacer-grounded portion PSU of the first spacer PS1 and the contact hole CH and which is connected to the adjacent metal layer ML7. This satisfies the demand that two metal layers ML penetrate the display area DA per pixel PX. However, the shape of the metal layer ML6 is not limited to this.

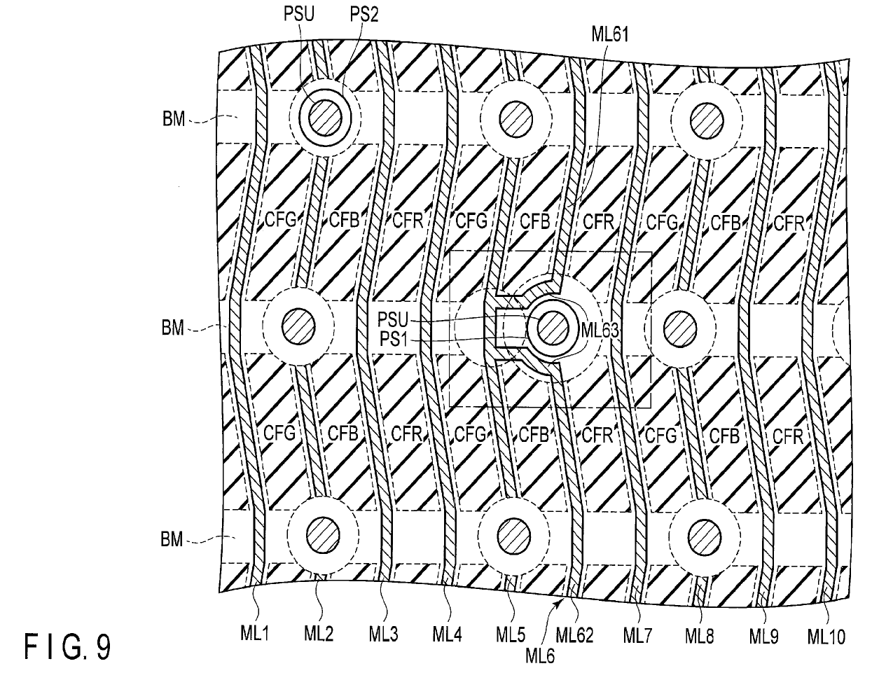

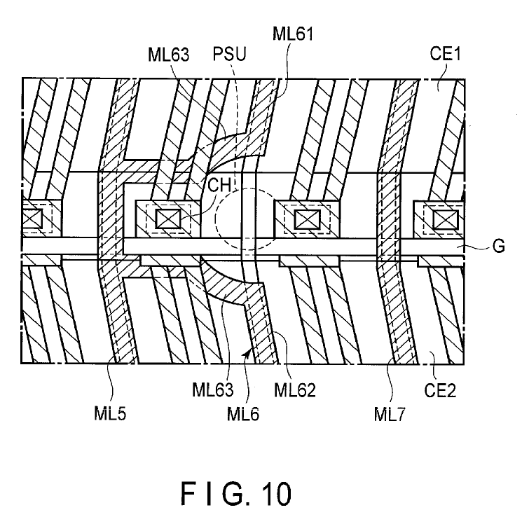

Specifically, the metal layer ML6 may be shaped as shown in FIG. 9 and FIG. 10. FIG. 9 and FIG. 10 are both schematic plan views showing another shape of the metal layer ML6. Specifically, FIG. 9 is a schematic plan view of the metal layer ML6 from the perspective of the array substrate AR side, and FIG. 10 is a schematic plan view of an area surrounded by an alternate long and short dashed line of FIG. 9 from the perspective of the counter-substrate CT side. The metal layer ML6 is provided to be adjacent to the metal layer ML5, and formed between the blue pixel SPXB and the red pixel SPXR, between which the first spacer PS1 is disposed. The metal layer ML6 includes the first portions ML61 and ML62 (second metal layers) separated at a point superposed on the gate line G, and the second portion ML63 (third metal layer) connecting the first portions ML61 and ML62 and the metal layer ML5.

The first portions ML61 and ML62 extend in a curve in the second direction Y. The second portion ML63 detours around the spacer-grounded portion PSU of the first spacer PS1. From one point of view, one end side of the second portion ML63 is connected to the first portion ML61, the other end side of the second portion ML63 is connected to the first portion ML62, and a middle portion of the second portion ML63 is connected to the metal layer ML5.

The first portions ML61 and ML62 are formed to be within black matrices BM formed between blue color filters CFB and red color filters CFR. In addition, most of the second portion ML63 is formed to be within a black matrix BM which shields the periphery of the first spacer PS1 from light. In FIG. 9, the shape of the black matrix BM corresponding to the first spacer PS1 is a circle as described above. Thus, the second portion ML63 is formed along the arc of the circular black matrix BM corresponding to the first spacer PS1.

As shown in FIG. 10, the first portions ML61 and ML62 of the metal layer ML6 are superposed on the source line S. As shown in FIG. 10, the second portion ML63 detours around the spacer-grounded portion PSU and the contact hole CH, and is connected to the metal layer ML5. The metal layers ML5 and ML6 connect the common electrodes CE1 and CE2 separated from each other.

As shown in FIG. 9, the second portion ML63 is connected to the metal layer ML5, which is divided at points at which the second spacers PS2 are disposed (that is, which does not function as a drive electrode TX). Thus, the connecting portion does not need to have the second line width W2, which is greater than the first line width W1, as shown in FIG. 6.

As described above, even if the metal layer ML6 near the first spacer PS1 is shaped as shown in FIG. 9 and FIG. 10, the demand that at least two metal layers ML penetrate the display area DA per pixel PX can be satisfied. Thus, the same advantages as described above can be obtained.

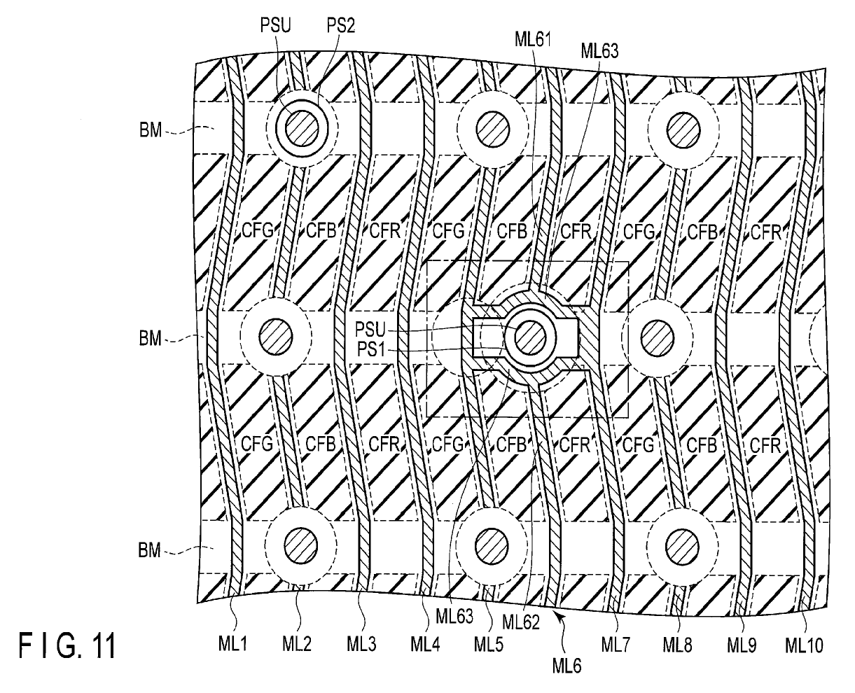

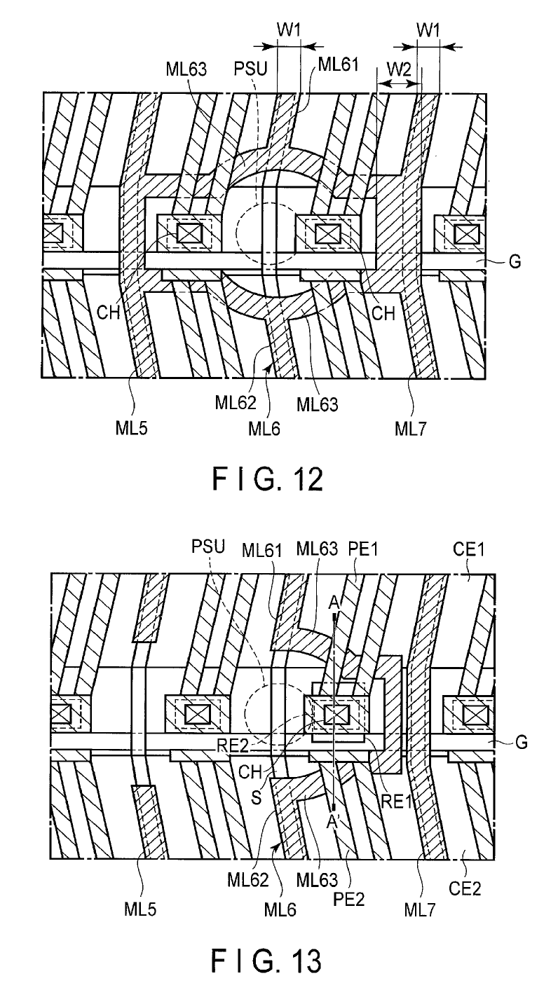

Furthermore, the metal layer ML6 may be shaped, for example, as shown in FIG. 11 and FIG. 12. FIG. 11 and FIG. 12 are both schematic plan views showing another shape of the metal layer ML6. Specifically, FIG. 11 is a schematic plan view of the metal layer ML6 from the perspective of the array substrate AR side, and FIG. 12 is a schematic plan view of an area surrounded by an alternate long and short dashed line of FIG. 11 from the perspective of the counter-substrate CT side. The metal layer ML6 is provided to be adjacent to each of the metal layers ML5 and ML7, and formed between the blue pixel SPXB and the red pixel SPXR, between which the first spacer PS1 is disposed. The metal layer ML6 includes the first portions ML61 and ML62 (second metal layers) separated at a point superposed on the gate line G, and the second portion ML63 (third metal layer) connecting the first portions ML61 and ML62 and each of the metal layers ML5 and ML7.

The first portions ML61 and ML62 extend in a curve in the second direction Y. The second portion ML63 detours around the spacer-grounded portion PSU of the first spacer PS1. From one point of view, one end side of the second portion ML63 is connected to the first portion ML61, the other end side of the second portion ML63 is connected to the first portion ML62, and a middle portion of the second portion ML63 is connected to each of the metal layers ML5 and ML7.

The first portions ML61 and ML62 are formed to be within black matrices BM formed between blue colors filter CFB and red color filters CFR. In addition, most of the second portion ML63 is formed to be within a black matrix BM which shields the periphery of the first spacer PS1 from light. In FIG. 11, the shape of the black matrix BM corresponding to the first spacer PS1 is a circle as described above. Thus, the second portion ML63 is formed along the arc of the circular black matrix BM corresponding to the first spacer PS1.

As shown in FIG. 12, the first portions ML61 and ML62 of the metal layer ML6 are superposed on the source line S. As shown in FIG. 12, the second portion ML63 detours around the spacer-grounded portion PSU and the contact hole CH, and is connected to each of the metal layers ML5 and ML7. The metal layers ML5 to ML7 connect the common electrodes CE1 and CE2 separated from each other.

As shown in FIG. 12, the first portion ML61 of the metal layer ML6 and the metal layer ML7 have the first line width W1. In addition, as shown in FIG. 12, the connecting portion between the second portion ML63 and the metal layer ML7 has the second line width W2 greater than the first line width W1. In the case of the present structure, it suffices that the second line width W2 is greater than or equal to the first line width W1. This enables each of the metal layers ML6 and ML7 to function as a drive electrode TX without causing an increase in the resistance.

The connecting portion between the second portion ML63 and the metal layer ML5 does not need to have the second line width W2, which is greater than the first line width W1. However, the width of the connecting portion of the metal layer ML5 can be made greater than width W1. In addition, the widths of the metal layer ML6 and the metal layer ML7, or the widths of curved line portions connecting the metal layer ML6 and the metal layer ML7 can also be made less than the width W1.

As described above, even if the shape of the metal layer ML6 near the first spacer PS1 is shaped as shown in FIG. 11 and FIG. 12, the demand that at least two metal layers penetrate the display area DA per pixel PX can be satisfied. Thus, the same advantages as described above can be obtained.

In FIG. 6, FIG. 10, and FIG. 12, the metal layer ML6 detours around the spacer-grounded portion PSU of the first spacer PS1 and the contact hole CH, and is connected to at least one of the adjacent metal layers ML5 and ML7. Accordingly, the demand that at least two metal layers ML penetrate the display area DA per pixel is satisfied, and the resistance of the drive electrodes TX is reduced. However, even if the metal layer ML6 is not connected to at least one of the adjacent metal layers ML5 and ML7, the demand that at least two metal layers ML penetrate the display area DA can be satisfied. Specifically, as shown in FIG. 13, the metal layer ML6 may merely detour around the spacer-grounded portion PSU of the first spacer PS1 and the contact hole CH without being connected to the adjacent metal layers ML5 and ML7.

In the present embodiment, it has been explained that each pixel PX is composed of a red pixel SPXR, a green pixel SPXG, and a blue pixel SPXB. However, each pixel PX may further comprise a white pixel SPXW. Of red, green, blue, and white, white is especially highly visible to human eyes. It is therefore preferable that the first spacers PS1 be provided between color filters corresponding to pixels other than white pixels SPXW. In addition, it is preferable that the second spacers PS2 be provided between color filters corresponding to pixels other than the red pixels SPXR, which make the greatest contribution to an improvement in transmittance. In light of the above, it is preferable that the first spacers PS1 be disposed between the red color filters CFR and the green color filters CFG. In addition, it is preferable that the second spacers PS2 be provided between the green color filters CFG and the blue color filters CFB. Accordingly, even if each pixel PX is composed of a red pixel SPXR, a green pixel SPXG, a blue pixel SPXB, and a white pixel SPXW, a liquid crystal display device with good display quality can be achieved. If each pixel PX includes a white pixel SPXW, the demand that at least two metal layers ML penetrate the display area DA per pixel PX can be satisfied without connecting the metal layers ML near the first spacers PS1 to the adjacent metal layers ML. Thus, the resistance of the drive electrodes TX can also be reduced.

According to the above-described embodiment, a liquid crystal display device with good quality can be provided.

Specifically, the transmittance can be improved by 3.6% as compared to that in the conventional art by setting the diameter of the first spacers PS1 at 9.0 μm and the diameter of the second spacers PS2 at 9.5 μm, and disposing a first spacer PS1 between a blue color filter CFB and one red color filter CFR per 16 pixels (four pixels in length×four pixels in width) and fifteen second spacers PS2 between green color filters CFG and blue color filters CFB per 16 pixels.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. For example, in the above-described embodiment, pixel electrodes are provided between common electrodes and a liquid crystal layer. However, the common electrodes and metal layers may be provided between the pixel electrodes and the liquid crystal layer. In addition, drive electrodes are provided in the second direction and arranged in the first direction. However, even if the drive electrodes are provided in the first direction, the common electrodes may be connected by the metal layers to reduce the resistance. The present invention is also applicable to such a structure.

What is claimed is:

1. A display device comprising:
a first substrate comprising a first signal line, common electrodes, and metal lines connecting to the common electrodes;
a second substrate opposed to the first substrate; and
a liquid crystal layer enclosed between the first substrate and the second substrate;
the metal lines comprising a first metal line crossing the first signal line, a second metal line provided separately from the first metal line, and a third metal line connecting the first metal line and the second metal line.

2. The display device of claim 1, wherein the first signal line is a scanning line.

3. The display device of claim 1, wherein the second substrate comprises a spacer projecting through the liquid crystal layer, and
the third metal line connects the first metal line and the second metal line at a point other than a point at which the spacer contacts the first substrate.

4. The display device of claim 1, wherein the first substrate comprises a second signal line and a third signal line crossing the first signal line, and
the first metal line is provided along the second signal line and the second metal lines is provided along the third signal line.

5. The display device of claim 1, wherein the third metal line is provided along the first signal line.

6. The display device of claim 3, wherein the second substrate comprises a light-shielding layer partitioning a pixel, and
the first to third metal lines and the spacer are superposed on the light-shielding layer.

7. The display device of claim 3, wherein the spacer is a main spacer determining a distance between the first substrate and the second substrate.

8. The display device of claim 7, wherein the metal lines comprise a fourth metal line provided to be adjacent to the first metal line, and
the fourth metal line is a metal line differing the second metal line, and is divided at points superposed on the first signal line.

9. The display device of claim 8, wherein the second substrate comprises sub-spacers differing from the main spacer at the points at which the fourth metal line is divided.

10. The display device of claim 1, wherein the first metal line is provided between a red pixel and a green pixel, and
the second metal line is provided between a blue pixel and a green pixel.

11. The display device of claim 8, wherein the fourth metal line is provided between a green pixel and a blue pixel.

12. The display device of claim 1, wherein each of the common electrodes functions as a drive electrode of a sensor by being electrically connected by the metal lines.

13. The display device of claim 1, wherein the first metal line has a first line width, and
a connecting portion between the first metal line and the third metal line has a second line width, the second line width being greater than the first line width.

14. The display device of claim 13, wherein the second line width is greater than or equal to 1.1 times the first line width but less than or equal to 3 times the first line width.

15. A display device comprising:
a first substrate comprising a first signal line, common electrodes, and metal lines connecting to the common electrodes;
a second substrate opposed to the first substrate; and
a liquid crystal layer enclosed between the first substrate and the second substrate,
the second substrate comprising a spacer projecting through the liquid crystal layer,
the metal lines comprising a first metal line crossing the first signal line and a second metal line provided to be adjacent to the first metal line and to detour around a point at which the spacer contacts the first substrate.

16. A display device comprising a substrate comprising a first signal line, first electrodes, and metal lines connecting to the first electrodes,
the metal lines comprising a first metal line crossing the first signal line, a second metal line provided separately from the first metal line, and a third metal line connecting the first metal line and the second metal line.

17. The display device of claim 16, wherein the substrate comprises a second signal lines and a third signal line crossing the first signal line,
the first metal line is provided along the second signal line and the second metal line is provided along the third signal line, and
the third metal line is provided along the first signal line.

18. The display device of claim 16, wherein the substrate further comprises second electrodes opposed to the first electrodes, and an interlayer film existing between the first and second electrodes.

19. The display device of claim 16, wherein the first to third metal lines are superposed on a light-shielding layer partitioning a pixel.
